(19) United States
(12) Patent Application Publication
(10) Pub. No.: US 2009/0281212 A1
(43) Pub. Date: Nov. 12, 2009

(54) ALKENYLSUCCINIC ANHYDRIDE SURFACE-APPLIED SYSTEM AND USES THEREOF

(76) Inventors: Lucyna Pawlowska, Norwalk, CT (US); Kimberly C. Dilts, Beacon Falls, CT (US); Charles R. Hunter, Winchester, VA (US); Michael P. O'Toole, Cheshire, CT (US); Robert J. Proverb, Woodbury, CT (US); Thomas T. Long, Norwalk, CT (US)

Correspondence Address: CANTOR COLBURN, LLP, 20 Church Street, 22nd Floor, Hartford, CT, 06103, US

(21) Appl. No.: 12/505,753

(22) Filed: Jul. 20, 2009

Related U.S. Application Data
(62) Division of application No. 10/533,190, filed on Apr. 28, 2005, now abandoned.

(51) Int. Cl. C08L 3/02; C08K 5/1539

(52) U.S. Cl. 524/47; 524/112

(57) ABSTRACT

The invention relates to an aqueous sizing composition including (a) an emulsion comprising alkenylsuccinic anhydride component containing alkenylsuccinic anhydride particles suspended in an aqueous polymer, and (b) a second component selected from the group consisting of cationic starches, non-ionic starches, anionic starches, water-soluble polymer, water and mixtures thereof, such that the alkenylsuccinic anhydride component is sufficiently dilute to enable the sizing composition to impart useful sizing properties to a fibrous substrate when the sizing composition contacts the fibrous substrate. The invention also relates to fibrous substrates treated with such a composition as well as processes for making and using the composition. In one embodiment, alkylene ketene dimer can be used instead of alkenylsuccinic anhydride.

### BACKGROUND

Papermakers would benefit from a simple, effective, cellulose-reactive surface-applied sizing agent system that (i) imparts useful sizing properties to fibrous substrates and (ii) reduces or eliminates the need to use sizing agents at the wet end of a papermaking process. Unfortunately, known methods and compositions have prevented papermakers from achieving this goal.

It is well known that the property of sizing, as applied to paper, refers to a fibrous substrate's ability to resist wetting or penetration of a liquid into a paper sheet. Aqueous dispersions of alkenylsuccinic anhydride (ASA) cellulose-reactive sizing agent have been widely used in the paper and board making industry for many years, for sizing a wide variety of grades which include printing and writing grades and bleached and unbleached board grades. Cellulose-reactive alkenylsuccinic anhydride emulsions impart hydrophobic properties to the paper and board products.

Chemicals used to achieve sizing properties are known as either internal sizes or surface sizes. Internal sizes can be either rosin-based or synthetic sizes such as alkenylsuccinic anhydride, or other materials. Internal sizes are added to the paper pulp prior to sheet formation. Surface sizes are sizing agents that are added after the paper sheet has formed, most generally at the size press, although spraying applications may also be used.

Alkenylsuccinic anhydride sizing agent is ordinarily applied by dispersing it in a cationic or amphoteric hydrophilic substance such as a starch or a polymer. The starch or polymer-dispersed alkenylsuccinic anhydride sizing emulsions have been added to the pulp slurry before the formation of a paper web. This type of addition of alkenylsuccinic anhydride sizing emulsions to the paper making system is commonly called wet-end addition or internal addition of alkenylsuccinic anhydride.

Unfortunately, the addition of alkenylsuccinic anhydride to the wet end of the papermaking machine has several disadvantages. Internally added alkenylsuccinic anhydride emulsions are never totally retained on the fiber. The portion that is not retained is free to react with water or other components of the paper making system and can form deposits at the wet-end of the paper machine, or can then be carried to the press or drying sections of the paper machine and form paper or board defects. Further, internal addition of alkenylsuccinic anhydride emulsions has the potential for interacting with other wet-end additives, such as brightening agents, defoamers or dispersants, biocides, dyes, strength agents, etc.

Further, increases in filler addition, such as calcium carbonate filler at the wet-end of the papermaking system have led to an increase in size demand as well. Filler particles have a relatively high surface area as compared to cellulose fiber and readily adsorb internally added sizing agents. Alkenylsuccinic anhydride, which is adsorbed onto calcium carbonate filler particles, leads to a less efficient sizing, requiring higher doses as compared to treatment of unfilled paper webs sized with cellulose reacted alkenylsuccinic anhydride sizing agent.

Efforts to develop compositions and methods that surface treat fibrous substrates have failed to produce a simple, effective system that imparts useful sizing properties to a fibrous substrate and that reduces or eliminates the need to use sizing agents at the wet end of a papermaking process. For example, conventional surface sizes, such as styrene acrylate emulsions, styrene acrylics, styrene maleic anydrides, polyurethanes and the like require an internal size to be efficient.

U.S. Pat. No. 6,162,328 discloses a method for sizing paper that adds a sizing composition containing mixtures of cellulose-reactive and cellulose non-reactive size dispersions to the surface of the paper. The cellulose non-reactive sizes are polymeric materials such as copolymers of styrene or substituted styrenes with vinyl monomers containing carboxyl groups. Cellulose-reactive sizes include sizes such as ketene dimers and multimers, alkenylsuccinic anhydrides, organic epoxides, acyl halides, fatty acid anhydrides from fatty acids and organic isocyanates. The starch may be of any type, including but not limited to oxidized, ethylated, cationic and pearl starch, and is preferably used in aqueous solution. The cellulose-reactive size dispersions and non-reactive size dispersions may be added with a solution of starch or starch derivative before being applied to the paper.

U.S. Pat. No. 6,162,328 requires the combination of at least one cellulose-reactive size and at least one cellulose non-reactive size. This combination allows one to add alkenylsuccinic anhydride or alkyl ketene dimer to the size press by balancing properties of both types. The requirement that combinations of polymeric materials be used makes the composition more expensive and complicated as compared to single sizing component addition.

U.S. Pat. No. 4,872,951 discloses blends of alkenylsuccinic anhydride-treated and cationic starches for use as external sizes of paper and paperboard products. The blends contain 30-90% (by wt.) of the alkenylsuccinic anhydride-treated starch, which is a monoester of the starch and an alkyl- or alkenylsuccinate and 10-70% (by wt.) cationic starch. The invention requires a reaction product of starch with alkenylsuccinic anhydride combined with cationic starch, which is added to the surface of the paper. Manufacturing this reaction product is an additional process step. In addition, the document's emphasis on cationic starches does not teach how non-ionic and anionic starches or polymer could be used in emulsions to effectively deliver alkenylsuccinic anhydride to a fibrous substrate and impart useful sizing properties.

WO 02/08514 describes the preparation of a sizing emulsion that contains a sizing agent, and an inorganic particulate emulsifying agent capable of forming an emulsion and water. The sizing agent can be 2-oxetanone dimer or multimer, alkenylsuccinic anhydride, rosin or carbamoyl chloride. The inorganic particulate emulsifying agent is selected from clay, silica, zeolite, mica, calcium carbonate, phosphate or sulfate; aluminum oxide, hydroxide, phosphate or silicate; magnesium phosphate or silicate; polyaluminum chloride, phosphate or silicate and ferrous or ferric phosphate, silicate or oxide. According to the patent, the addition of the inorganic particulate emulsifying agent allows one to add alkenylsuccinic anhydride to the size press. Example 28, a comparative example, discloses that a conventionally prepared alkenylsuccinic anhydride “emulsion comprising surfactant and starch does not work in the size press . . . .”

U.S. Pat. No. 4,629,655 discusses a sizing agent that contains a cationic polymer suitable as a retention aid and a size suitable for sizing. The product is solid, preferably a tablet wherein the normally liquid size is substantially dispersed in the cationic polymer. The sizing agent is intended for internal sizing only. Manufacturing this sizing agent requires an additional step and solids are more difficult to disperse than emulsions.

U.S. Pat. No. 4,606,773 discloses a method to emulsify alkenyl succinic anhydride-type paper sizing agent wherein a water-soluble polymer is used in conjunction with a water-soluble starch. Incorporating an amount of starch into the polymer enhances the stability of the ASA emulsion. The sizing agent is intended for internal sizing only. The requirement that a combination of starch and polymer makes the composition more expensive and complicated as compared to a single sizing composition.

U.S. Pat. No. 5,627,224 discusses an aqueous sizing composition in which the sizing agent is selected from cyclic dicarboxylic acid anhydride or alkyl ketene dimer, a stabilizing agent and/or dispersing agent, which are an amphoteric polymer and a polyaluminum compound. The requirement that a combination of starch or polymer and a polyaluminum compound makes the composition more expensive and complicated as compared to a single sizing composition.

U.S. Pat. No. 5,969,011 and WO 98/33979 disclose an aqueous dispersion of a sizing agent containing a cellulose reactive agent and a dispersant system comprising a low molecular weight cationic polymer and an anionic stabilizer, which is an anionic polymer. The compounds are preferably bound together by the force of electrostatic attraction, thereby representing a coacervate dispersant. The requirement that a combination of a cationic polymer and an anionic dispersant makes the composition more expensive and complicated as compared to a single sizing composition.

U.S. Pat. No. 4,657,946 discusses the process of preparing sized paper products in which emulsified alkenyl succinic anhydride sizing agent contains water, alkenylsuccinic anhydride, surfactants and cationic polymer. The process is added to paper stock. The requirement that a combination of a cationic polymer and surfactant makes the composition more expensive and complicated as compared to a single sizing composition.

The above-mentioned documents are typical of the deficiencies of known art that fail to provide examples or meaningful details that would enable an artisan to practice a simple, effective, cellulose-reactive surface-applied sizing agent system that (i) imparts useful sizing properties to fibrous substrates at conditions typically found in papermaking operations (at a temperature that is more than about 40° F., e.g., more than above 120° F. (about 49° C.) or above and (ii) reduces or eliminates the need to use sizing agents at the wet end of a papermaking process. The documents do not disclose systems that would be useful in conditions where hydrolyzed alkenylsuccinic anhydride would be expected to form.

For the foregoing reasons, there is a need to develop a simple, surface-applied, effective, cellulose-reactive surface-applied sizing agent system under ordinary operating conditions that (i) imparts useful sizing properties to fibrous substrates and (ii) reduces or eliminates the need to use sizing agents at the wet end of a papermaking process.

### SUMMARY

The invention relates to an aqueous composition comprising (a) an emulsion comprising alkenylsuccinic anhydride component containing alkenylsuccinic anhydride particles suspended in an aqueous polymer, and (b) a second component selected from the group consisting of cationic starches, non-ionic starches, anionic starches, water-soluble polymers, water, and mixtures thereof, such that the alkenylsuccinic anhydride component is sufficiently diluted to enable the sizing composition to impart useful sizing properties to a fibrous substrate when the sizing composition contacts the fibrous substrate.

In one embodiment, the invention relates to an aqueous sizing composition comprising (a) an emulsion comprising alkylene ketene dimer component containing alkylene ketene dimer particles suspended in an aqueous polymer solution, and (b) a second component selected from the group consisting of cationic starches, non-ionic starches, anionic starches, water-soluble polymer, water, and mixtures thereof, such that the alkylene ketene dimer component is sufficiently dilute to enable the sizing composition to impart useful sizing properties to a fibrous substrate when the sizing composition contacts the fibrous substrate.

The invention also relates to fibrous substrates treated with such compositions, methods for making the composition, and methods of using the composition.

These and other features, aspects, and advantages of the present invention will become better understood with reference to the following description and appended claims.

### DESCRIPTION

The invention relates to an aqueous sizing composition comprising (a) an emulsion comprising alkenylsuccinic anhydride component containing alkenylsuccinic anhydride particles suspended in an aqueous polymer and (b) a second component selected from the group consisting of cationic starches, non-ionic starches, anionic starches, water-soluble polymers, water and mixtures thereof, such that the alkenylsuccinic anhydride component is sufficiently diluted to enable the sizing composition to impart useful sizing properties to a fibrous substrate when the sizing composition contacts the fibrous substrate.

Such a sizing composition can be made by a process having the sequential steps of (a) emulsifying an alkenylsuccinic anhydride component, optionally containing a surfactant, with an aqueous polymer solution, and thereby forming an emulsion, and (b) combining the emulsion with a second component selected from the group consisting of cationic starches, non-ionic starches, anionic starches, water-soluble polymers, water and mixtures thereof, and thereby forming the sizing composition. In one embodiment, alkyl ketene dimer is used instead of alkenylsuccinic anhydride. In another embodiment, mixtures of alkenylsuccinic anhydride and alkyl ketene dimer are used.

The invention is based on the remarkable discovery that by emulsifying (1) an alkenylsuccinic anhydride component containing (i) alkenylsuccinic anhydride and, optionally, (ii) a surfactant component, with an (2) aqueous polymer; forming an emulsion, and then combining the emulsion with a second component selected from the group of cationic starches, non-ionic starches, anionic starches, water-soluble polymers, water and mixtures thereof, under carefully controlled conditions, it is now possible to make a simple, yet highly effective sizing composition that imparts useful sizing properties to a fibrous substrate at a temperature typically found at a size press. The invention is also based on the discovery that even if the sizing composition made in accordance to the invention contains hydrolyzed alkenylsuccinic anhydride (HASA), the sizing composition can impart useful sizing properties to fibrous substrates. Advantageously, the use of the sizing composition reduces or eliminates deposition or sticking at the size press, calendar stack, or drying section of a paper machine.

Other advantages of the instant invention are the elimination of the need for starch, its preparation and the need for biological growth control required in starch processing; the ability to utilize the sizing composition at elevated temperatures; eliminate the need to cook or handle starch; polymers provide stable ASA emulsion at very low ratios of polymer to ASA.

The phrase “useful sizing properties” as used herein, means sizing properties that are useful for a paper product's intended use. Conversely, the phrase “useless sizing properties” as used herein, means sizing properties of that are not useful for a paper product's intended use. The term “emulsion” as used herein refers to emulsions made in accordance with the invention, which when combined with a second component, forms a sizing composition that is particularly useful when applied at any appropriate location in a papermaking process afterwhich a fibrous sheet has formed, e.g., a size press or coater.

The invention relates to an aqueous sizing composition comprising: (a) an emulsion comprising alkenylsuccinic anhydride component containing alkenylsuccinic anhydride particles suspended in an aqueous polymer, and (b) a second component selected from the group consisting of cationic starches, non-ionic starches, anionic starches, water-soluble polymer, water and mixtures thereof, such that the alkenylsuccinic anhydride component is sufficiently diluted to enable the sizing composition to impart useful sizing properties to a fibrous substrate when the sizing composition contacts the fibrous substrate.

The sizing composition of the invention is specially designed for use at size presses. The sizing composition of this invention reduces or eliminates the need for the use of sizing agents at the wet end of a papermaking process. Of course, the sizing composition of the invention can be used for any other application in which a surface of a fibrous substrate can be treated.

The emulsion generally includes an alkenylsuccinic anhydride component containing alkenylsuccinic anhydride particles suspended in an aqueous polymer. Optionally, the alkenylsuccinic anhydride component may also contain a surfactant component.

The alkenylsuccinic anhydride component generally includes alkenylsuccinic anhydride compounds composed of mono unsaturated hydrocarbon chains containing pendant succinic anhydride groups. The alkenylsuccinic anhydride compounds are generally liquid and may be derived from maleic anhydride and suitable olefins. The alkenylsuccinic anhydride compounds may be solid.

Generally speaking, the alkenylsuccinic anhydride compounds may be made by reacting an isomerized C₁₄-C₂₀ mono olefin, preferably an excess of an internal olefin, with maleic anhydride, at a temperature and for a time sufficient to form the alkenylsuccinic anhydride compound.

If the olefin to be employed in the preparation of the alkenylsuccinic anhydride compounds is not an internal olefin as is the case for example, with α-olefins, it may be preferable to first isomerize the olefins to provide internal olefins. The olefins that may be used in the preparation of the alkenylsuccinic anhydride compounds may be linear or branched. Preferably, the olefins may contain at least about 14 carbon atoms. Typical structures of alkenylsuccinic anhydride compounds are disclosed, for example, in U.S. Pat. No. 4,040,900, incorporated herein by reference in its entirety. Alkenylsuccinic anhydride compounds and methods for their preparation are described, for example, in C. E. Farley and R. B. Wasser, “The Sizing of Paper, Second Edition,” edited by W. F. Reynolds, TAPPI Press, 1989, pages 51-62, the disclosures of which are hereby incorporated herein by reference in its entirety.

The alkenylsuccinic anhydride component may contain some hydrolyzed alkenylsuccinic anhydride. The amount of hydrolyzed alkenylsuccinic anhydride may range from about 1 to about 99 wt. %, based on the total weight of the alkenylsuccinic anhydride component.

The alkenylsuccinic anhydride component is generally present in the emulsion in an amount that is at least about 0.01 wt. %, or from about 0.1 to about 20 wt. %, or from about 0.3 wt. % to about 15 wt. %, based on the total weight of the emulsion. In another embodiment, the alkenylsuccinic anhydride component is present in the emulsion in an amount that is from about 20 to about 40 wt. %.

The polymer used to emulsify the alkenylsuccinic anhydride can be any polymer, which when used in accordance with the invention, can produce an emulsion in accordance with the invention. Examples of suitable polymers used in the emulsion of this sizing composition include polymeric stabilizers that include vinyl addition and condensation polymers having anionic, cationic, non-ionic and amphoteric charge characteristics with a charge substitution range varying from 0 to about 90%, and more preferably from 0 to about 10%. Further, the molecular weight of aforementioned synthetic polymeric stabilizer generally falls within the value ranging from about 10,000 to about 10 million daltons, or from about 100,000 to about two million or from about 200,00 to about 1 million daltons. All molecular weights mentioned herein are weight average.

Generally, suitable water-soluble polymers of this instant invention are cationic vinyl addition polymers, anionic vinyl addition polymers, neutral polymers, ampholytic polymers and condensation polymers. Examples of suitable polymers include, water-soluble polymers having molecular weights ranging from 10,000 daltons to 3,000,000 daltons. The substantially water-soluble polymers to be used in this invention are comprised of but not limited to homopolymers and copolymers, and combinations thereof leading to terpolymers, and tetrapolymers comprised of the following monomers: acrylamide, diallyldimethylammonium chloride, dimethylaminoethylacrylate, dimethylaminoethylacrylate quaternaries, diethylaminoethyl acrylate, diethylaminoethylacrylate quaternaries, dimethylaminoethylmethacrylate, dimethylaminoethylmethacrylate quaternaries, dimethylaminoethylmethacrylate and its quaternaries, methacrylamidopropyltrimethyl ammonium chloride, acrylic acid. Suitable polymers also include polymers and copolymers of acrylamide that have been subjected to the “Mannich” reaction. Also, in one embodiment, the corresponding Mannich quaternaries are possible water-soluble polymers. Examples of other water-soluble polymers include copolymers comprised of substantially water-soluble and water dispersible styrene-alkylacrylates, styrene alkylacrylics, styrene maleic acid, styrene-maleic acid amide, styrene maleic acid esters, styrene maleic acid amide ester, and their corresponding salts. In another embodiment, suitable polymers include aqueous dispersions containing combinations of the reaction products of the above monomers, polyurethane dispersions with polyvinyl alcohol, poly vinylalcohol-vinylamine), their corresponding acetates or formamates or partially hydrolyzed polymers, or polyvinylamine.

Examples include copolymers of N,N-dialkylamino-alkyl(meth) acrylates and/or amides and/or alkyl(meth)acrylates, styrene, isobutylene, diisobutylene, vinyl acetate and/or acrylonitrile. Examples include condensation polymers of trimethylene diamine and 1,2-dichloroethane or 1,3 dichloropropane; adipic acid with diethylenetriamine, tetraethylene-pentamine or similar polyalkylene; polyamides; subsequent reaction products with epichlorohydrin; dimethylamine-epichlorohydrin; ethylene-diamine polyacrylamide. Examples include polyvinyl pyridine, poly-N-methylpyridinium chloride; poly-p-chlorostyrene quaternized with trialkylamine. Examples of such suitable polymers are described in U.S. Pat. Nos. 4,657,946, 4,784,727, 3,445,330, 6,346,554, incorporated herein by reference in their entirety.

Natural polymers, gums, and their extracts included in the embodiments of the invention may be taken from the following list: guar, acacia, agar, algin, carrageenan, cellulose and its derivatives, chitin, chitosan, damar, dextran, dextrin, ethylcellulose, gelatin, gellan, jalap, karaya, kelp, locust bean, methlycellulose, olibanum, pectin, rhamsan, sandarac, tragacanth, welan, and xanthan This includes the salts and derivatives of the natural polymers The polymers may be in their natural state or derivatized thereafter to form salts or other derivatives (e.g. hydroxyethylated). The products may be anionic, cationic, amphoteric, or neutral.

Generally, the emulsifying polymer is present in the emulsion at an alkenylsuccinic anhydride: water-soluble polymer weight ratio that is at least about 1:0.05. In one embodiment, the polymer is generally present in the emulsion at an alkenylsuccinic anhydride: water-soluble polymer weight ratio that ranges from about 1:0.1 to about 1:1, preferably from about 1:0.1 to about 1:0.5, or most preferably from about 1:0.1 to about 1:0.2.

The preferred pH range of the water-soluble polymer component should be 3.0 to 9.0, most preferably 4.0 to 8.0. The preferred temperature of the water-soluble polymer component should be 40 to 150° F. (4 to 66° C.), most preferably 55 to 100° F. (13 to 38° C.).

The surfactant component includes surfactants, which when used to make an emulsion in accordance with the invention produces an emulsion that minimizes coalescing and imparts useful sizing properties to a fibrous substrate after the emulsion contacts the fibrous substrate. Generally, the surfactants are anionic or nonionic or can be cationic and can have a wide range of HLB values. Examples of suitable surfactants include but are not limited to alkyl and aryl primary, secondary and tertiary amines and their corresponding quaternary salts, sulfosuccinates, fatty acids, ethoxylated fatty acids, fatty alcohols, ethoxylated fatty alcohols, fatty esters, ethoxylated fatty esters, ethoxylated triglycerides, sulfonated amides, sulfonated amines, ethoxylated polymers, propoxylated polymers or ethoxylated/propoxylated copolymers, polyethylene glycols, phosphate esters, phosphonated fatty acid ethoxylates, phosphonated fatty alcohol ethoxylates, and alkyl and aryl sulfonates and sulfates. Examples of preferred suitable surfactants include but are not limited to amides; ethoxylated polymers, propoxylated polymers or ethoxylated/propoxylated copolymers; fatty alcohols, ethoxylated fatty alcohols, fatty esters, carboxylated alcohol or alkylphenol ethoxylates; carboxylic acids; fatty acids; diphenyl sulfonate derivatives; ethoxylated alcohols; ethoxylated fatty alcohols; ethoxylated alkylphenols; ethoxylated amines; ethoxylated amides; ethoxylated aryl phenols; ethoxylated fatty acids; ethoxylated triglycerides; ethoxylated fatty esters; ethoxylated glycol esters; polyethylene glycols; fatty acid esters; glycerol esters; glycol esters; certain lanolin-based derivatives; monoglycerides, diglycerides and derivatives; olefin sulfonates; phosphate esters; phosphorus organic derivatives; phosphonated fatty acid ethoxylates, phosphonated fatty alcohol ethoxylates; polyethylene glycols; propoxylated and ethoxylated fatty acids; alkyl and aryl sulfates and sulfonates; ethoxylated alkylphenols; sulfosuccinamates; sulfosuccinates.

In one embodiment, the surfactant component includes an amine selected from the group consisting of trialkyl amine of the formula (I):

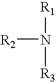

dimethyl sulfate quaternary salt of trialkyl amine of the formula (I), benzyl chloride quaternary salt of trialkyl amine of the formula (I), and diethyl sulfate quaternary salt of trialkyl amine of the formula (I), in which R₁ is methyl or ethyl, R₂ is methyl or ethyl, and R₃ is alkyl having 14 to 24 carbon atoms. In another embodiment, the surfactant component excludes this amine.

When the alkenylsuccinic anhydride is emulsified with a suitable polymer, the emulsification may be carried out with surfactants. The surfactant levels for the surfactant component can range from about 0.1 weight % up to about 20 weight % based on the alkenylsuccinic anhydride component.

The particles of the emulsion generally have a median particle size that is about 0.5 microns or higher. The median particle size of the emulsion can vary, depending on the application, the type of polymer used for emulsification, and the polymer properties. In one embodiment, the median particle size of the emulsion ranges from about 0.1 to about 50 microns, or from about 0.5 to about 30 microns. It will be appreciated that the particles suspended by the water can exhibit a wide range of particle distributions. The ability to use an emulsion having such a wide range of particle distributions is advantageous, because they are easier to prepare. It is generally recognized that emulsions used in wet end applications require relatively narrower and smaller particle size distributions to provide effective sizing. The particle size distribution of the emulsion of this invention is preferably mono-modal. However, in some cases, the distribution can be bimodal or multimodal.

The emulsion is generally made by emulsifying (a) a suitable amount of alkenylsuccinic anhydride and, optionally, a surfactant component with (b) a suitable amount of polymer under conditions that produce an emulsion, which when combined with a second component, forms a sizing composition that imparts useful sizing properties to a fibrous substrate when the sizing composition contacts a fibrous substrate. For instance, the emulsion is made by passing the alkenylsuccinic anhydride component, polymer and a suitable amount of water through a shearing device that provides sufficient energy to form an emulsion. The alkenylsuccinic anhydride should not be exposed to water before emulsification process.

The pressure and temperature at which the emulsion is made are sufficient to make an emulsion that can be combined with the second component and form a sizing composition that imparts useful sizing properties to a fibrous substrate when the sizing composition contacts a fibrous substrate. In one embodiment, the inlet pressure of a suitable emulsification device, e.g., a shearing device, is about 1 to about 25 psig at a temperature ranging from about 40 to about 150° F. (from about 4 to about 66° C.), and the outlet pressure ranges from about 15 to about 160 psig at a temperature ranges from about 40 to about 170° F. (from about 4 to about 77° C.). The primary polymer solution flow to a suitable shearing device, e.g., a Burks pump, can range from about 0.8 to about 2.0 gallon per minute (gpm), preferably about 0.25 to about 1 gpm. In one embodiment, the emulsion may be made under low shear conditions, e.g., those shearing conditions are created by a device selected from the group of centrifugal pumps, static in-line mixers, peristaltic pumps, magnetic stirring bar in a beaker, overhead stirrer, and combinations thereof.

The second component is selected from the group of (i) a starch component (cationic starches, non-ionic starches, and/or anionic starches) (ii) a water-soluble polymer, or (iii) water, (and mixtures thereof) such that the alkenylsuccinic anhydride component is sufficiently dilute to enable the sizing composition to impart useful sizing properties to a fibrous substrate when the sizing composition contacts the fibrous substrate. The starch component can generally be any starch, which when used in accordance with the invention, produce a sizing composition that imparts useful sizing properties to a fibrous substrate when the sizing composition contacts a fibrous substrate. Generally, the starch component includes starches that have been modified and are generally anionic or non-ionic in nature. However, the starch component can include amphoteric or cationic starches, e.g., starches that are also used in size presses.

Suitable starches are typically anionic or nonionic, and may include those where the base corn, potato, wheat, tapioca or sorghum is modified through the use of enzymes, high temperatures, and or chemical/thermal converting techniques. Chemical modifications include but are not limited to oxidation, acid modification, heat, acetylation, and hydroxyethylation. Examples of suitable starches include but are not limited to Penford's Douglas® 3012 oxidized dent corn starch, Cargill's Filmflex® 60 hydroxyethylated dent corn starch, and Staley's Ethylex® 2035 hydroxyethylated dent corn starch.

The starch component can be used in the form of an aqueous starch solution. The viscosity of a starch solution can vary from about 10 cP to about 200 cP at a typical size press solution temperature. Advantageously, typical hot starch temperatures can be used and the sizing composition containing the emulsion can still impart useful sizing properties. The temperature of the starch component can be any temperature, provided that the alkenylsuccinic anhydride component and the second component are sufficiently diluted to enable the sizing composition to impart useful sizing properties to a fibrous substrate when the sizing composition contacts the fibrous substrate. A preferred temperature of the starch component is from more than about 40 to about 150° F. (from about 4° C. to about 66° C.), or about 200° F. (or about 94° C.) most preferrably from about 55 to about 100° F. (from about 13° C. to about 38° C.). In one embodiment, the starch temperature varies from about 60 to about 200° F. (from about 15 to about 94° C.). The starch solids need also not be modified, but can be if desired. The starch solids can range from about 1 to about 20 wt. %, and preferably from about 5 to about 13 wt. %. In one embodiment, the pH of the starch component can be used at its autogenous pH. The pH of the starch component is generally from about 5 to 9, or preferably from about 7 to about 8.5.

Water alone is not typically added to emulsions used at a size press. In this invention, however, when water is used as a second component, the water which is typically used in papermaking processes at wet end applications can be used. The water can be added by any suitable means, e.g., a line feed. The preferred pH range of the papermaking water should be from about 4.0 to about 9.0, most preferrably from about 5.0 to about 8.0. The temperature of the water can be any temperature, provided that the alkenylsuccinic anhydride component and the second component are sufficiently diluted to enable the sizing composition to impart useful sizing properties to a fibrous substrate when the sizing composition contacts the fibrous substrate. The preferred temperature of the water component should be from more than about 40 to about 150° F. (from more than about 4° C. to about 66° C.), or about 200° F. most preferrably from about 55 to about 100° F. (from about 13° C. to about 38° C.). Advantageously, when water is used as the second component, the starch component and the water-soluble polymer component do not have to be used in any appreciable amount, preferably none.

Water is the major component of the sizing composition. Generally, the water forms at least about 95 wt. %, or at least about 90 wt. % or at least about 80 wt. % of the sizing composition. The preferred pH range of the papermaking water should be 4.0 to 9.0, most preferrably 5.0 to 8.0. The preferred temperature of the water ranges from about 40 to about 150° F., most preferrably from about 55 to about 100° F. In another embodiment, the water-soluble polymers component may be the same component used in the emulsification or may be other polymers. The water-soluble component is used in an amount that is sufficient to make a sizing composition in accordance with the invention.

Generally, the water-soluble polymer component is present in the sizing composition from 0.01 wt % to 20 wt %. In one embodiment, the water-soluble polymer component is generally present in the sizing composition from about 0.05 wt % to about 10 wt %; preferably from 0.075 wt % to about 5 wt %; and most preferably from about 0.1 wt % to about 1 wt %. The temperature of the water-soluble polymer component can be any temperature, provided that the alkenylsuccinic anhydride component and the second component are sufficiently diluted to enable the sizing composition to impart useful sizing properties to a fibrous substrate when the sizing composition contacts the fibrous substrate. The preferred temperature of the water-soluble polymer component is from more than about 40 to about 150° F. (from about 4° C. to about 66° C.), or about 200° F. most preferrably from about 55 to about 100° F. (from about 13° C. to about 38° C.).

The sizing composition is made by combining the first component (an emulsion including alkenylsuccinic anhydride component containing alkenylsuccinic anhydride particles suspended in an aqueous polymer solution) with the second component (cationic starches, non-ionic starches, anionic starches, water-soluble polymers, water, and/or mixtures thereof). The first component can be combined with the second component by any suitable means, e.g., by mixing. Preferably, the emulsion and the second component are combined in-line. When the first component is made a temperature that is less than about 40° C., the first component is generally heated by the second component when the first component is combined with the second component, such that the temperature of the resulting sizing composition ranges from more than about 40° F., e.g. from more than about 40 to about 200° F. (from about 4° C. to about 94° C.) or 150° F. (66° C.), or from about 55 to about 100° F. (from about 13° C. to about 38° C.). Alternatively, when the first component is made at a temperature that is more than above about 40° F., the temperature of the resulting aqueous sizing composition is also generally more than above 40° F., e.g. from more than about 40° F., or 50° F. (10° C.) to about 200° F. (about 94° C.). When the first component is made at a temperature that is more than above about 40° F., the temperature of the first component is generally lower than the temperature of the second component. In one embodiment, when the first component is made at a temperature that is more than above about 40° F., the temperature of the first component is the same or greater than the temperature of the second component. As such, the first component is not added directly to a surface of a fibrous substrate, but rather the first component is combined with the second component to form an aqueous sizing composition under conditions that would be expected to cause hydrolysis, and then the resulting sizing composition is added to the fibrous substrate.

In another embodiment, the sizing composition further contains surface sizing agents. However, this is not necessary. Suitable surface sizing agents include but are not limited to styrene maleic anhydride copolymers, styrene acrylic acid copolymers, polyurethane dispersions and styrene acrylate emulsions. Preferred styrene maleic anhydride copolymers are copolymers of styrene or substituted styrene with vinyl monomers such as maleic anhydride and their partially esterified or hydrolyzed counterparts. An example is Baysize® S 48 polymer. Preferred styrene acrylic acid copolymers are copolymers of styrene or substituted styrene with vinyl monomers such as acrylic acid and methacrylic acid. Examples are Baysize® S 210 and 225 polymer. Preferred polyurethane dispersions are copolymers of isocyanate or diisocyanates and amines or alcohols. Examples are Graphsize® A, C, and T. Preferred styrene acrylate emulsions are copolymers of styrene, substituted styrene or acrylonitrile with acrylate or methacrylate esters. Examples are Baysize® S AGP, BMP and 850 polymers, Basoplast® 400DS styrene acrylate emulsion. On a dry basis, the ratio of the alkenylsuccinic anhydride component to the additional sizing agent ranges from about 1:0.2 to about 1:50.

In one embodiment, the sizing composition contains less than about 1 to 50 wt. % of an additional sizing agent to the alkenylsuccinic anhydride component. In other embodiments, the sizing composition contains more than about 0.5:1 wt. ratio additional sizing agent to the alkenylsuccinic anhydride component, or less than about 50:1 wt. ratio additional sizing agent to the alkenylsuccinic anhydride component.

The fibrous substrate treated with the sizing composition can be any substrate of a paper product, which when treated with the sizing composition made in accordance to the invention, acquires sizing properties that are suitable for its intended use. In one embodiment, the fibrous substrate includes bleached and unbleached paper or paperboard containing calcium carbonate, titanium dioxide, and clay filled paper products. The paper product made from the fibrous substrate may include paper or board, bleached or unbleached that is treated on the surface in a size press or by spraying with a sizing composition of the invention.

The invention is particularly beneficial for sizing board products, fine paper products, or newsprint paper products. Board is typically a paper machine produced fiber web of heavier weight than writing paper. Generally, the weight of board ranges from about 120 to about 400 grams per square meter, (gsm). Board pulps can be bleached or unbleached virgin softwood, hardwood types or be made of a blend of recycled paper composed of one or more of the following: corrugated boxes, old newsprint, mixed office waste, and old magazines, the latter two containing calcium carbonate filler. Newsprint is essentially wood-containing coated and uncoated magazine and newspaper papers made from ground wood pulp, which is pulp not chemically treated, or a combination of groundwood, and recycled furnishes. Fine paper generally is referred to as printing and writing paper, excluding newsprint. Generally, the weight of fine paper ranges from about 40 to about 120 grams per square meter, (gsm). Specific applications include magazines, catalogs, books, commercial printing, copying and business forms, and stationary. The pulp used in the majority of these grades is chemically treated, with limited recycle or wood-containing pulp. Printing and writing paper are generally made from bleached chemical pulps, (e.g., kraft pulping or sulfite pulping), and contain calcium carbonate levels of from about 5 to about 30%. They may also partially contain deinked/recycled bleached waste paper, (sorted mixed office waste).

In use, the invention encompasses a process for sizing a paper product that involves (a) forming a fibrous sheet from a pulp slurry, and (b) treating a surface of the fibrous sheet with the sizing composition of this invention. The sizing composition of the invention is added to a surface of a fibrous substrate at an amount that is sufficiently high to impart useful sizing properties to the resulting paper product. The sizing composition can be added to a fibrous substrate by any way that enables the sizing composition to adsorb onto the surface of the fibrous substrate. The sizing composition penetrates into the fibrous substrate in an amount depended on surface applied starch pick-up. In one embodiment, the sizing composition can be applied to unbleached kraft or wood containing papers. The sizing composition is preferably made on-site and used soon after it is prepared.

In one embodiment, the sizing composition is applied onto the surface of the formed web at an alkenylsuccinic anhydride component dosage (pounds per ton of dry paper; lb/ton) that is at least about 0.1 lb/ton, or from about 0.1 to about 10 lb/ton, or from about 0.5 to about 5 lb/ton, or preferably from about 0.5 to about 3.0 lb/ton. Particularly advantageous dosages of the alkenylsuccinic anhydride component for making board paper products range from about 1.5 to about 3.0, preferably from about 1.5 to about 2.5 pounds per ton of dry paper. Particularly advantageous dosages for making fine paper products range from about 0.1 to about 5 pounds per ton of dry paper, or from about 0.5 to about 2.0 lb/ton, or preferably from about 0.5 to about 1.5 pounds per ton of dry paper. Particularly advantageous dosages for making newsprint paper products range from about 0.1 to about 5 lb/ton, from about 0.1 to about 3 lb/ton or from about 0.1 to about 1.5 lb/ton. Other suitable ranges may be from about 0.1 to about 1.0 lb/ton, preferably from about 0.2 to about 0.7 pounds per ton of dry paper.

Stated in weight percent, the amount of the alkenylsuccinic anhydride component in the fibrous substrate can be at least about 0.005 wt. % and can range from about 0.005 to about 1 wt. %, based on weight of fibrous substrate produced, or preferably from about 0.025 to about 0.5 wt. % on the same basis.

The temperature at which the sizing composition is used is generally less than about 190° F. (about 88° C.), and can range from about 40° F. to about 190° F. (4° C. to about 88° C.), or from about 140° to about 160° F. (60 to about 71° C.). The pH condition in which the sizing composition is used is generally from about 4.5 to about 9, or from about 7 to about 8.

A fibrous substrate treated with a sizing composition of the invention acquires sizing properties that are appropriate for its intended use. Generally, a fine paper product made with the sizing composition will exhibit sizing properties that have at least 20 seconds of ink penetration holdout, as described in TAPPI standard method T530 om96, preferably from about 20 to about 500 seconds, or preferably from about 50 to about 200 seconds.

For board products, the sizing composition is capable of sizing a board fibrous substrate so that the resulting paper product exhibits a Cobb sizing value (based on 2 minute test) ranging from about 50 to about 120 grams per square meter, depending on end use of the board produced. Cobb sizing is a measure of the amount of liquid, generally water, which is adsorbed into the surface of a board or paper sample in a pre-stated amount of time, (in this case 2 minutes) using standardized equipment and procedures as described in TAPPI Method T441 om98. Alternatively, a board paper product made with the sizing composition can exhibit Cobb sizing values ranging from about 30 to about 120 gsm, or preferably from about 50 to about 80 gsm.

For fine paper products, the sizing composition is capable of sizing a fibrous substrate so that the resulting paper product exhibits a Cobb sizing value (based on 1 minute) ranging from about 18 to about 40 gsm. Alternatively, depending on the grade of fine paper, the invention can impart from 20 Seconds Hercules Size Test (HST, also known as “TAPPI 530”, 1% formic acid, 80% reflectance) to 500 seconds of resistance to penetration.

For newsprint paper products, the sizing composition is capable of sizing a fibrous substrate, and producing a resulting paper product that exhibits sizing properties ranging from about 10 to about 100 seconds, as measured by a water drop test (based on 5 μL water drop size), depending on end use of publication grades being made. Water drop test is a commonly used test in newsprint applications where the time for the water drop to penetrate into the fibrous substrate is measured.

Paper products made with the sizing composition of the invention can also contain an internally added sizing agent so that pre-size press sizing has anywhere from about 2 to about 10 seconds of HST for good size press runnability.

When it is desirable to practice a process in which some sizing agent is added to the wet end, a wet end sizing agent component is added to a pulp slurry and a fibrous sheet is formed from the slurry. The fibrous sheet is then treated with a sizing composition of the invention and the fibrous substrate is sized.

The wet end sizing agent component can include any sizing agent that is used in the wet end such as rosin or rosin emulsions, and includes those sizes believed to be capable of forming covalent chemical bonds by reaction with the hydroxyl groups of cellulose. Suitable sizes for use in the wet end sizing agent component include ketene dimers and multimers, alkenylsuccinic anhydrides, organic epoxides containing from about 12 to 22 carbon atoms, acyl halides containing from about 12 to 22 carbon atoms, fatty acid anhydrides from fatty acids containing from about 12 to 22 carbon atoms and organic isocyanates containing from about 12 to 22 carbon atoms. Ketene dimers and multimers are known and described in U.S. Pat. No. 6,162,328, incorporated herein in its entirety.

In one embodiment, the wet end sizing agent component contains cationic starch. Suitable cationic starches include those starches that are typically used in the wet end. In another embodiment, the wet end sizing agent component contains cationic polymer and alkenylsuccinic anhydride. In another embodiment, the wet end sizing component can be the emulsion used to make the sizing composition of the invention. In this embodiment, some emulsion that would ordinarily be used to make the sizing composition of this invention is reserved for use as the wet end sizing component. When cellulose-reactive sizing agents are added to the wet end and the sizing composition of the invention is used to surface treat a fibrous substrate, the weight ratio of (i) the sizing agent applied at the wet-end to (ii) the weight ratio of the alkenylsuccinic anhydride component in the sizing composition, is preferably less than about 1:1, or preferably less than about 0.5:1.

Applicants do not understand why, despite subjecting the sizing composition of this invention to conditions which cause rapid hydrolysis of alkenylsuccinic anhydride, the sizing composition imparts useful sizing properties to fibrous substrates. Without being bound by theory, it is believed that the alkenylsuccinic anhydride component is sufficiently diluted to enable the sizing composition to impart useful emulsifying and stabilizing properties.

The invention reduces or eliminates the amount of sizing agent used at the wet end, and thereby reduces or eliminates wet end interaction with other chemical additives and furnish components that are known to cause paper machine cleanliness problems. In one embodiment, the alkenylsuccinic anhydride in the wet end sizing agent component is 50% or less of the total alkenylsuccinic anhydride used during an operating period. In another embodiment, the alkenylsuccinic anhydride in the wet end is present in an amount that is 40% or less, or 30% or less than 20% or less than 10% of the total cellulose-reactive sizing agents used during an operating period.

The alkenylsuccinic anhydride component contained in the sizing composition, when applied to a surface of a fibrous substrate, is retained in the fibrous substrate at higher levels as compared to when alkenylsuccinic anhydride is added to a pulp slurry.

The invention also enables its user to produce the same amount of paper that would ordinarily be produced by known processes by using less sizing agent. In one embodiment, the invention uses less than 50 percent or from about 70 to about 30 percent less sizing agent that is used in an ordinary process and still produces the same amount of paper without the problems ordinarily encountered with known sizing processes. The invention also provides a system that enables its user to use less amounts of alkenylsuccinic anhydride without sacrificing the quality or amount of paper that is produced at a mill.

Since problems ordinarily encountered with conventional sizing processes are avoided and a higher retention of size is obtained by directly treating a fibrous substrate, it is now possible for papermakers to produce more paper with less sizing agent than they have been accustomed to using. The invention allows papermakers to run papermaking machines for prolonged period of times without problems typically encountered with ordinary sizing compositions, e.g., problems with runnability, deposit formation, or inconsistent quality of paper products. The invention, for instance, allows paper machines to be run for long periods of time without visible deposition to the size press or calendar stack.

The invention is primarily directed to presently preferred embodiments in which the sizing composition of the invention is made with an emulsion containing an alkenylsuccinic anhydride component. The invention, however, also includes embodiments in which the emulsion is made with cellulose-reactive agents other than alkenylsuccinic anhydride. For instance, in one embodiment, the sizing composition can be made with an emulsion containing emulsified cellulose-reactive agents selected from the group consisting of isocyanates, alkyl ketene dimer (AKD) and acid anhydrides.

As such, in one embodiment, the invention can be made or practiced with AKD instead of ASA. As used herein, the term “AKD” refers to alkyl and alkenyl ketene formed into dimers with a chemical structure accepted by those of ordinary skill in the art where AKD contains a hydrophobic group containing more than about 4 carbon atoms and selected from alkyl, alkenyl, aralkyl or aralkenyl groups, as defined above.

Preferably, each hydrocarbon group is, independently, a hydrophobic group containing from about 4 carbon atoms to about 36 carbon atoms. AKD sizing agents are described in detail in several references, for example, U.S. Pat. Nos. 3,992,345 and 5,510,003; in J. W. Davis et al., TAPPI 39 (1), 21 (1956); and in R. E. Cates et al., “Alkyl Ketene Dimer Sizes”, Chapter 2 in The Sizing of Paper, 2nd Edition, W. F. Reynolds, Ed., Tappi Press, 1989, pp. 33-50. Specific examples of AKD sizing agents useful in the instant invention include but are not limited to octyl ketene dimer, decyl ketene dimer, dodecyl ketene dimer, tetradecyl ketene dimer, hexadecyl ketene dimer, octadecyl ketene dimer, eicosyl ketene dimer, docosyl ketene dimer, tetracosyl ketene dimer, and those prepared by known methods from organic acids and naturally occurring mixtures of fatty acids such as those found in palmitoleic acid, oleic acid, rincinoleic acid, linoleic acid, linolenic acid, coconut oil, palm oil, olive oil and peanut oil. Mixtures of any of such acids may also be used. Preferred AKD sizing agents include but are not limited to those comprising at least one alkyl or alkenyl group comprising from about 8 to about 36 carbon atoms. More preferred AKD sizing agents include but are not limited to hexadecyl, octadecyl and oleyl ketene dimer. It is understood that the embodiments in which AKD is used instead of ASA, the description of the sizing compositions containing ASA described above (and methods of making and using the compositions) can also be used for sizing compositions in which AKD is used. Accordingly, when the term “alkenylsuccinic anhydride” or “ASA” is used above to describe the invention, the term “AKD” can be also be used instead of the term “alkenylsuccinic anhydride” or “ASA.” In one embodiment, the AKD excludes 2 oxetanone ketene multimer.

The invention is further described in the following illustrative examples in which all parts and percentages are by weight unless otherwise indicated.

### EXAMPLES

### Materials, Experimental Procedures, Tests

### Experimental Procedures

### Paper Preparation Procedures

The papers used in these examples were prepared from two sources. The first sets of paper were made using a pilot paper machine. The furnish was comprised of 30% bleached softwood kraft refined to 420 Canadian Standard Freeness and 70% bleached hardwood kraft refined to 350 Canadian Standard Freeness. Two types of paper were made. Paper A was a 70 g/m² sheet containing 14.9% calcium carbonate (ALBACAR® 5970, Specialty Minerals, Inc.) and pre-determined amounts of added internal size, ASA sizing agent, (BAYSIZE® I 18 synthetic size, Bayer Chemicals Corporation). Starch sizing emulsions prepared for use in internal addition are made with cationic starch (Hi-Cat® CWS starch, Penford), ASA internal size at a weight ratio of 1:1, (starch:size) using a Ross Homogenizer. An anionic, polyacrylamide retention aid was used in each preparation.

Paper B was a 70 g/m² sheet containing 14.9% calcium carbonate (ALBACAR® 5970). This paper doesn't contain internal size.

The second set of papers, Paper C, was prepared on a commercial paper machine from mixed office waste. The basis weight of this paper was 126 g/m². This paper contains 7 weight percent calcium carbonate and no internal size.

### Surface Application Procedure A

The appropriate sizing composition was used to treat paper samples. The desired dosage was calculated based upon the liquid pick-up of the composition on the dry paper sheet. This was determined by measuring the weight difference between the dry sheet and the sheet that has been dipped into the surface treatment solution (and pressed). The test papers are cut to a suitable size, weighed, dipped into the various sizing compositions, pressed at a pressure of 12 psig, and then dried at 240° F. for 35 seconds. The dose levels are reported in lb/ton, i.e., pounds of dry sizing agent per ton of dry paper.

### Surface Application Procedure B

The appropriate paper was produced on a pilot paper machine. At the size press, the appropriate sizing composition was used to treat the paper. The sizing composition was feed to the size press from a run tank, with excess material being recirculated to the run tank. The desired dose was calculated based upon the liquid pick-up of the composition on the dry paper. This was determined by measuring the volume uptake of the starch solution at the size press. The paper was then fed directly into the second drier section and wound at the reel.

### Surface Application Procedure C

A Werner Mathis laboratory size press was adapted for use in flooded-nip, paper size press applications. The laboratory flooded-nip size press consists of two, hard rubber rollers. The nip pressure between these two rollers was adjusted according to the basis weight of the paper. The speed of rollers was varied to optimize pick-up. Pick-up of the size press solutions was determined by weighing test sheets before and after passing through the nip contain the targeted size press liquid. The test liquids are then dosed with the appropriate amount of treatment solution (real solids based upon dry starch pick-up). Test solutions are added to the nip and the paper sample was fed through the nip. The dose was expressed as pounds of real substrate per ton of dry paper. The treated paper sample was immediately passed through a rotary drum dryer heated at 240° F. for 35 sec.

### ASA Emulsion Preparation Procedure A

In a household blender a solution of polymer or a solution of starch was added. The blender was turned on low speed, and into the vortex was introduced ASA (Baysize® S 180 synthetic size, Bayer Chemicals Corporation). Upon completion of addition, the speed was changed to high for three minutes.

### Treatment Effectiveness Tests

The treatment effectiveness of the sizing agents and conditions was determined by performing some of the various test described below. The general procedures for these tests are provided below. All paper samples are then conditioned at 50% relative humidity and 70° C. for 24 hours before testing.

### Test A Ink Penetration Holdout

Ink Penetration Holdout was measured using a method similar to that described in TAPPI Method T 530 pm-89 except that an instrument was used as described in U.S. Pat. No. 5,483,078. The test measures the time (in seconds) for the reflectance of the paper on the side opposite that contacting the ink to decreases to 80% of the initial value. The ink consists of 1.25% Napthol Green B dye buffered to pH 7. The test values are normalized for basis weight of the paper assuming that the values vary as the cube of the basis weight. Results are expressed in units of seconds.

### Test B Ultrasonic Attenuation Measurement

This analytical technique records the change in intensity of an ultrasonic signal transmitted through a paper sample while one of its faces was in contact with a liquid. Measurements were made using a Penetration Dynamics Analyzer (PDA) (Emtec Electronic, Gmbh). Two parameters are recorded for these examples. The “A-value” corresponds to liquid absorption into the paper, was a dimensionless number and correlates with the Cobb value (Test I). The “Max” value was characteristic of surface hydrophobicity and was reported in seconds. Typically, three handsheets are tested per treatment with one test per side, felt and wire, for a total of two tests per sheet and six tests per set. These numbers are averaged to provide either the A-value or the Max value for that set.

Test C Water Absorption. Cobb Test

This test was performed according to TAPPI Test Method T441 om-90. A two-minute hold time.

### Image Analysis

Image analysis was performed using an Optomax Sorcerer image analysis system equipped with morphometry application software, a stereo zoom microscope with CCD camera and ring fiber optic illumination. Several types of tests are used.

### Test D Black Image Analysis

A commercially available ink jet printer was used to print onto a test sheet several rows of the letter “H” comprised of bold, 8 point, Arial font. The areas of the four letters were then measured and averaged to provide the “black letter area.” A smaller letter area corresponds to less spreading or wicking of the inked area. Results are expressed in units of mm².

### Test E Color Bleed

Color bleed was determined by measuring the areas of black letters printed on a yellow background, in a similar fashion as described in the Black Image Analysis; a color inkjet printer must be used. Images of four letters are averaged to provide the “letter area.” A smaller letter area corresponds to less spreading or wicking of the inked area. Results are expressed in units of mm².

### Test F Optical Density

Solid, black areas of at least 1-cm² were printed onto the sheet to be tested. The optical density (OD) of the printed areas was measured with a commercially available X-Rite Spectrodensitometer. Values are the average of five measurements. The values are dimensionless. A higher optical density value was generally indicative of improved printability.

### Test G Toner Adhesion

The toner adhesion test measured the adhesion of print toner to paper. The test was conducted by copying a testing pattern consisting of nine black blocks (of dimension 1-inch×2-inch) onto a sample sheet using a commercially available photocopier. The samples are then folded along the center of the block and rolled with a 4.5-pound roller. The crease was lightly brushed to remove the excess toner. The image analyzer was used as in the black image analysis to measure the area of white produced along the crease. Nine measurements are made for each treatment. Lower area values are indicative of higher toner adhesion. Results are reported in units of mm².

### Test H Emulsion Particle Size

Commercially available, light scattering, particle analyzers, Horiba LA-300 and Horiba LA-700, are used to determine the particle size of the emulsions. Results are reported as the median particle size in microns.

### Examples 1-7

Examples 1-7 compare the performance of ASA emulsified with polymers to the performance of ASA emulsified with starch and to the performance of a commercial size press agent.

### Starch Solution A

A starch solution was prepared by making a 15% starch solids slurry of a commercially available surface size starch (Filmflex® 60 starch, Cargill) in deionized water that has been adjusted to pH 7.0+/−0.2 with either 0.5N HCl or 0.5N NaOH, (hereby referred to as Treated Water A) and heating the mixture to 95° C. for 1 hour.

### Starch Solution A 1

A total of 80 parts of Starch Solution A was added to 320 parts of deionized water to yield a 3 wt % Starch Solution (A1). The pH of this solution was adjusted to 7.0+/−0.2 either with 0.5N HCl or 0.5N NaCl.

### Example 1

A 2% solids solution of an amphoteric polyacrylamide Baysize® E HS polymer (Bayer Chemicals Corporation) was prepared by mixing 27.64 parts of 25% solids polymer with 317.86 parts of deionized water adjusted to pH 4.0.

An ASA emulsion was prepared with the polymer solution at an ASA/polymer solids ratio of 1/0.2, using Emulsification Procedure A. The emulsion was made by emulsification of 34.5 parts of BaysizeS 180 size with 345.5 parts of the polymer solution. This was Emulsion A1.

According to Surface Application Procedure A, Paper A (70 g/m² sheets containing 14.9 wt % calcium carbonate) was treated with a mixture of 2.0 parts of Emulsion A1 and 400 parts of Starch Solution A1. In this manner, 0.5 lb of ASA per ton of dry fiber was added.

### Example 2

The procedure of Example 1 was repeated, except that Paper A was treated with a mixture of 3.0 parts of Emulsion A1 and 400 parts of Starch Solution A1 In this manner, 0.75 lb of ASA per ton of dry fiber was added.

### Example 3

A 2% solids solution of an anionic polyacrylamide Baystrength® 85 resin (Bayer Chemicals Corporation) was prepared by mixing 31.41 parts of 22% solids polymer with 314.09 parts of deionized water adjusted to pH 4.0.

An ASA emulsion was prepared with the polymer solution at an ASA/polymer solids ratio of 1/0.2, using Emulsification Procedure A. The emulsion was made by emulsification of 34.5 parts of Baysize S 180 size with 345.5 parts of the polymer solution. This was Emulsion B1.

According to Surface Application Procedure A, Paper A was treated with a mixture of 2.0 parts of Emulsion B1 and 400 parts of Starch Solution A1. In this manner, 0.5 lb of ASA per ton of dry fiber was added.

### Example 4

The procedure of Example 2 was repeated, except that Paper A was treated with a mixture of 3.0 parts of Emulsion B1 and 400 parts of Starch Solution A1 In this manner, 0.75 lb of ASA per ton of dry fiber was added.

### Example 5

### Comparative

An ASA emulsion was prepared with Starch Solution A at an ASA/starch solids ratio of 1/1. The emulsion was made by emulsification of 7.7 parts of Baysize S 180 size with 51.28 parts Starch Solution A and 141.02 parts of deionized water, using a household blender on high speed for 90 sec. This was Emulsion C.

According to Surface Application Procedure A, Paper A was treated with a mixture of 4.7 parts of Emulsion C and 400 parts of Starch Solution A1 in such manner that 0.5 lb of ASA per ton of dry fiber was added.

### Example 6

### Comparative

The procedure of Example 5 was repeated, except that Paper A was treated with a mixture of 7.1 parts of Emulsion C and 400 parts of Starch Solution A1. In this manner, 0.75 lb of ASA per ton of dry fiber was added.

### Example 7

### Comparative

According to the Surface Application Procedure A, Paper A was treated with a mixture of 4.5 parts of surface size agent Baysize® S BMP polymer, a styrene-acrylate emulsion (Bayer Chemicals Corporation) and 400 parts of Starch Solution A1. In this manner, 3.0 lb of the active surface size agent per ton of dry fiber was added.

### Summary of Examples 1-7

Ink penetration holdout (Test A), black image analysis (Test D), color bleed (Test E) and optical density (Test F) were measured on treated paper (Examples 1, 2, 3, 4, 5, 6, and 7) and are presented in Table 1.

TABLE 1

| | Type of | | Ink | | | |
|---|---|---|---|---|---|---|
| | Sizing | | Pene- | | | |
| | Agent | | tration | | | |
| Exam- | ASA/ | Dose | Anal- | Black | Black | Color |
| ple | Emulsifier | (lb/ | ysis | Image | Optical | Bleed |
| # | Ratio | ton) | (sec) | (mm²) | Density | (mm²) |
| 1 | ASA/amphoteric | 0.5 | 502 | 2.038 | 1.426 | 2.295 |
| | polymer 1/0.2 | | | | | |
| 2 | ASA/amphoteric | 0.75 | 651 | 2.044 | 1.438 | 2.271 |
| | polymer 1/0.2 | | | | | |
| 3 | ASA/anionic | 0.5 | 489 | 2.068 | 1.438 | 2.301 |
| | polymer 1/0.2 | | | | | |
| 4 | ASA/anionic | 0.75 | 515 | 2.037 | 1.428 | 2.256 |
| | polymer 1/0.2 | | | | | |
| 5 | ASA/starch 1/1 | 0.5 | 494 | 2.047 | 1.436 | 2.324 |
| compar- | | | | | | |
| ative | | | | | | |
| 6 | ASA/starch 1/1 | 0.75 | 777 | 2.042 | 1.438 | 2.312 |
| compar- | | | | | | |
| ative | | | | | | |
| 7 | surface sizing | 3 | 374 | 2.073 | 1.398 | 2.324 |
| compar- | agent | | | | | |
| ative | | | | | | |

The results in Table 1 show that a lower dose of ASA emulsified with polymer provided significantly better sizing than the conventional surface sizing agent at a much higher dose (Example 7).

These examples show that the use of the polymer in the instant invention provides equivalent performance to the starch prepared composition but with the advantages associated with the use of polymer described above.

### Examples 8-9

Examples 8 and 9 illustrate the performance of ASA emulsified with polymers and applied at the size press of the pilot paper machine to treat the paper that wasn't internally sized. No deposits or runnability issues were encountered.

### Starch Solution B

A 15-wt % Filmflex® 60 starch solution was prepared according to the preparation procedure of Starch Solution A, except that tap water was used in this preparation.

Starch Solution B1

A total of 3500 parts of Starch Solution B was diluted with 14000 parts of tap water to yield a 3-wt % starch solution. The pH of this solution was adjusted to 7.0+/−0.2 with either 0.5N HCl or 0.5N NaOH.

### Example 8

ASA Emulsion A1 was prepared with the amphoteric polyacrylamide Baysize E HS polymer at an ASA/polymer solids ratio of 1/0.2, as it was described in Example 1, except that tap water was used in this preparation.

A mixture of 177.8 parts of Emulsion A1 and 17500 parts of Starch Solution B1 was added to the emulsion run tank. According to the Surface Application Procedure B, Paper B (70 g/m² sheets containing 14.9% calcium carbonate and no internal size) was treated with the emulsion delivered from the run tank. In this manner, 1.5 lb of ASA per ton of dry fiber was added.

### Example 9

ASA emulsion was prepared with Starch Solution B at a ASA/starch solids ratio of 1/1. The emulsion was made by emulsification of 100 parts of Baysize S 180 size with 667 parts of Starch Solution B and 762 parts of tap water in a commercial blender on low speed for 30 sec. The temperature of starch solution was 36° C. The ASA concentration in the emulsion was 6.5 wt %. This was Emulsion E.

A mixture of 248.37 parts of Emulsion E and 17500 parts of Starch Solution B1 was added to the emulsion run tank. According to the Surface Application Procedure B, Paper B was treated with the emulsion delivered from the run tank in such manner that 1.5 lb of ASA per ton of dry fiber was added.

### Summary of Examples 8-9

Ink penetration holdout (Test A), black image analysis (Test D), color bleed (Test E), optical density (Test F) and toner adhesion (Test G) were measured on treated paper and are presented in Table 2.

TABLE 2

| | Emulsion | | | | | | |
|---|---|---|---|---|---|---|---|
| | Type | | | Black | | | |
| | ASA/ | ASA | Ink | Image | Color | | Toner |
| Example | Emulsifier | Dose | Penetration | Analysis | Bleed | Optical | Adhesion |
| # | Ratio | (lb/ton) | (sec) | (mm²) | (mm²) | Density | (mm²) |
| 8 | ASN/amphoteric | 1.5 | 149 | 1.911 | 2.035 | 1.358 | 1.813 |
| | polymer | | | | | | |
| | 1/0.2 | | | | | | |
| 9 | ASA/starch | 1.5 | 163 | 1.875 | 2.017 | 1.372 | 1.961 |
| | 1/1 | | | | | | |

There was no visible deposits formed on the size press during application of ASA emulsion prepared with the amphoteric polymer. The results in Table 2 show that the ASA/polymer emulsion provided equivalent performance in sizing and print quality testing within the limits of test standard deviation.

### Examples 10-31

These examples demonstrate the effect of ASA to polymer ratio during the emulsification process on the emulsion performance.

### Example 10

A 1% solids solution of the amphoteric polyacrylamide Baysize E HS polymer (Bayer Chemicals Corporation) was prepared by mixing of 4.0 parts of 25% solids polymer with 96.0 parts of deionized water adjusted to pH4.0.

An ASA emulsion was prepared with the polymer solution at an ASA/polymer solids ratio of 1/0.05, using Emulsification Procedure A. The emulsion was made by emulsification of 20.0 parts of Baysize S 180 size with 100.0 parts of the polymer solution. The emulsion was diluted to 1.96 weight percent ASA concentration by mixing 11.76 parts of the emulsion with 88.24 parts of deionized water. This was Emulsion A2.

A size press solution was prepared by adding 7.6 parts of Emulsion A2 to 150 parts of starch Solution A1.

According to Surface Application Procedure C, Paper C (126 g/m² sheets containing 7 wt % calcium carbonate and no internal size) was treated with the size press solution in such manner that 1.75 lb of ASA per ton of dry paper was added.

### Example 11

The procedure of Example 10 was repeated, except that the size press solution was prepared by adding 8.6 parts of Emulsion A2 to 150 parts of Starch Solution A1. In this manner, 2 lb of ASA per ton of dry paper was added.

### Example 12

A 2% solids solution of an amphoteric polyacrylamide Baysize E HS polymer (Bayer Chemicals Corporation) was prepared by mixing 16.0 parts of 25% solids polymer with 184.0 parts of deionized water adjusted to pH 4.0.

An ASA emulsion was prepared with the polymer solution at an ASA/polymer solids ratio of 1/0.1, using Emulsification Procedure A. The emulsion was made by emulsification of 20.0 parts of Baysize S 180 size with 100.0 parts of the polymer solution. The emulsion was diluted to 1.96 weight percent ASA concentration by mixing 11.76 parts of the emulsion with 88.24 parts of deionized water. This was Emulsion A3.

A size press solution was prepared by adding 7.6 parts of Emulsion A3 to 150 parts of starch Solution A1. (The preparation of Starch Solution A1 is described in the set of Examples 1-7.)

According to Surface Application Procedure C, Paper C was treated with the size press solution in such manner that 1.75 lb of ASA per ton of dry paper was added.

### Example 13

The procedure of Example 12 was repeated, except that the size press solution was prepared by adding 8.6 parts of Emulsion A3 to 150 parts of Starch Solution A1. In this manner, 2 lb of ASA per ton of dry paper was added.

### Example 14

A 2% solids solution of an amphoteric polyacrylamide Baysize E HS polymer was prepared as it was described in Example 12. An ASA emulsion was prepared with the polymer solution at an ASA/polymer solids ratio of 1/0.2, using Emulsification Procedure A. The emulsion was made by emulsification of 10.91 parts of Baysize S 180 size with 109.09 parts of the polymer solution. The emulsion was diluted to 1.96 weight percent ASA concentration by mixing 21.56 parts of the emulsion with 78.44 parts of deionized water. This was Emulsion A4.

A size press solution was prepared by adding 7.6 parts of Emulsion A4 to 150 parts of starch Solution A1.

According to Surface Application Procedure C, Paper C was treated with the size press solution in such manner that 1.75 lb of ASA per ton of dry paper was added.

### Example 15

The procedure of Example 14 was repeated, except that the size press solution was prepared by adding 8.6 parts of Emulsion A4 to 150 parts of Starch Solution A1. In this manner, 2 lb of ASA per ton of dry paper was added.

### Example 16

A 2% solids solution of an amphoteric polyacrylamide Baysize E HS polymer was prepared as it was described in Example 12. An ASA emulsion was prepared with the polymer solution at an ASA/polymer solids ratio of 1/0.5, using Emulsification Procedure A. The emulsion was made by emulsification of 4.62 parts of Baysize S 180 size with 115.38 parts of the polymer solution. The emulsion was diluted to 1.96 weight percent ASA concentration by mixing 50.91 parts of the emulsion with 49.09 parts of deionized water. This was Emulsion A5. A size press solution was prepared by adding 7.6 parts of Emulsion A5 to 150 parts of starch Solution A1.

According to Surface Application Procedure C, Paper C was treated with the size press solution in such manner that 1.75 lb of ASA per ton of dry paper was added.

### Example 17

The procedure of Example 16 was repeated, except that the size press solution was prepared by adding 8.6 parts of Emulsion A5 to 150 parts of Starch Solution A1. In this manner, 2 lb of ASA per ton of dry paper was added.

### Example 18

A 2% solids solution of an amphoteric polyacrylamide Baysize E HS polymer was prepared as it was described in Example 12. An ASA emulsion was prepared with the polymer solution at an ASA/polymer solids ratio of 1/1, using Emulsification Procedure A. The emulsion was made by emulsification of 2.35 parts of Baysize S 180 size with 117.65 parts of the polymer solution. The ASA concentration in this emulsion was equal to 1.96 weight percent. This was Emulsion A6.

A size press solution was prepared by adding 7.6 parts of Emulsion A6 to 150 parts of starch Solution A1.

According to Surface Application Procedure C, Paper C was treated with the size press solution in such manner that 1.75 lb of ASA per ton of is dry paper was added.

### Example 19

The procedure of Example 16 was repeated, except that the size press solution was prepared by adding 8.6 parts of Emulsion A6 to 150 parts of Starch Solution A1. In this manner, 2 lb of ASA per ton of dry paper was added.

### Example 20

A 1% solids solution of a cationic polyacrylamide Baysize® E LS polymer (Bayer Chemicals Corporation) was prepared by mixing of 10.0 parts of 10% solids polymer with 90.0 parts of deionized water adjusted to pH 4.0.

An ASA emulsion was prepared with the polymer solution at an ASA/polymer solids ratio of 1/0.05, using Emulsification Procedure A. The emulsion was made by emulsification of 20.0 parts of Baysize S 180 size with 100.0 parts of the polymer solution. The emulsion was diluted to 1.96 weight percent ASA concentration by mixing 11.76 parts of the emulsion with 88.24 parts of deionized water. This was Emulsion F1.

A size press solution was prepared by adding 7.6 parts of Emulsion F1 to 150 parts of starch Solution A1.

According to Surface Application Procedure C, Paper C was treated with the size press solution in such manner that 1.75 lb of ASA per ton of dry paper was added.

### Example 21

The procedure of Example 20 was repeated, except that the size press solution was prepared by adding 8.6 parts of Emulsion F1 to 150 parts of Starch Solution A1. In this manner, 2 lb of ASA per ton of dry paper was added.

### Example 22

A 2% solids solution of a cationic polyacrylamide Baysize E LS polymer was prepared by mixing of 24.0 parts of 10% solids polymer with 96.0 parts of deionized water adjusted to pH 4.0. An ASA emulsion was prepared with the polymer solution at an ASA/polymer solids ratio of 1/0.1, using Emulsification Procedure A. The emulsion was made by emulsification of 20.0 parts of Baysize S 180 with 100.0 parts of the polymer solution. The emulsion was diluted to 1.96 weight percent ASA concentration by mixing 11.76 parts of the emulsion with 88.24 parts of deionized water. This was Emulsion F2. A size press solution was prepared by adding 7.6 parts of Emulsion F2 to 150 parts of starch Solution A1.

According to Surface Application Procedure C, Paper C was treated with the size press solution in such manner that 1.75 lb of ASA per ton of dry paper was added.

### Example 23

The procedure of Example 22 was repeated, except that the size press solution was prepared by adding 8.6 parts of Emulsion F2 to 150 parts of Starch Solution A1. In this manner, 2 lb of ASA per ton of dry paper was added.

### Example 24

A 2% solids solution of a cationic polyacrylamide Baysize E LS polymer was prepared as it was described in Example 22. An ASA emulsion was prepared with the polymer solution at an ASA/polymer solids ratio of 1/0.2, using Emulsification Procedure A. The emulsion was made by emulsification of 10.91 parts of Baysize S 180 size with 109.09 parts of the polymer solution. The emulsion was diluted to 1.96 weight percent ASA concentration by mixing 21.56 parts of the emulsion with 78.44 parts of deionized water. This was Emulsion F3.

A size press solution was prepared by adding 7.6 parts of Emulsion F3 to 150 parts of starch Solution A1.

According to Surface Application Procedure C, Paper C was treated with the size press solution in such manner that 1.75 lb of ASA per ton of dry paper was added.

### Example 25

The procedure of Example 24 was repeated, except that the size press solution was prepared by adding 8.6 parts of Emulsion F3 to 150 parts of Starch Solution A1. In this manner, 2 lb of ASA per ton of dry paper was added.

### Example 26

A 2% solids solution of a cationic polyacrylamide Baysize E LS polymer was prepared as it was described in Example 22. An ASA emulsion was prepared with the polymer solution at an ASA/polymer solids ratio of 1/0.5, using Emulsification Procedure A. The emulsion was made by emulsification of 4.62 parts of Baysize S 180 size with 115.38 parts of the polymer solution. The emulsion was diluted to 1.96 weight percent ASA concentration by mixing 50.91 parts of the emulsion with 49.09 parts of deionized water. This was Emulsion F4.

A size press solution was prepared by adding 7.6 parts of Emulsion F4 to 150 parts of starch Solution A1.

According to Surface Application Procedure C, Paper C was treated with the size press solution in such manner that 1.75 lb of ASA per ton of dry paper was added.

### Example 27

The procedure of Example 25 was repeated, except that the size press solution was prepared by adding 8.6 parts of Emulsion F4 to 150 parts of Starch Solution A1. In this manner, 2 lb of ASA per ton of dry paper was added.

### Example 28

A 2% solids solution of a cationicpolyacrylamide Baysize E LS polymer was prepared as it was described in Example 22. An ASA emulsion was prepared with the polymer solution at an ASA/polymer solids ratio of 1/1, using Emulsification Procedure A. The emulsion was made by emulsification of 2.35 parts of Baysize S 180 size with 117.65 parts of the polymer solution. The ASA concentration in this emulsion was equal to 1.96 weight percent. This was Emulsion F5.

A size press solution was prepared by adding 7.6 parts of Emulsion F5 to 150 parts of starch Solution A1.

According to Surface Application Procedure C, Paper C was treated with the size press solution in such manner that 1.75 lb of ASA per ton of dry paper was added.

### Example 29

The procedure of Example 28 was repeated, except that the size press solution was prepared by adding 8.6 parts of Emulsion F5 to 150 parts of Starch Solution A1. In this manner, 2 lb of ASA per ton of dry paper was added.

### Example 30

### Comparative

An ASA emulsion was prepared with Starch Solution A at an ASA/starch solids ratio of 1/1, using Emulsification Procedure A. (The preparation of Starch Solution A is described in the set of Examples 1-7.) The emulsion was made by emulsification of 8.0 parts of Baysize S 180 size with 53.76 parts of Starch Solution A and 138.24 parts of deionized water. The emulsion was diluted to 1.96 weight percent ASA concentration by mixing 49.0 parts of the emulsion with 51.0 parts of deionized water. This was Emulsion G.

A size press solution was prepared by adding 7.6 parts of Emulsion G to 150 parts of Starch Solution A1.

According to Surface Application Procedure C, Paper C was treated with the size press solution in such manner that 1.75 lb of ASA per ton of dry paper was added.

### Example 31

### Comparative

The procedure of Example 30 was repeated, except that the size press solution was prepared by adding 8.6 parts of Emulsion G to 150 parts of Starch Solution A1. In this manner, 2 lb of ASA per ton of dry paper was added.

### Summary of Examples 10-31

Water absorption (Test C), ultrasonic attenuation (Test B), black image (test D), color bleed (Test E) and optical density (Test F) were measured on treated paper and are reported in Table 3.

The median particle size of each ASA emulsion was measured with Horiba LA 300 and was included in Table 3.

TABLE 3

| | ASA Emulsion | | | | | | | | Median |
|---|---|---|---|---|---|---|---|---|---|
| | Type | ASA | 2-min | | | Black | Black | Color | Particle |
| | ASA/Emulsifier | Dose | Cobb | A- | Max | Image | Optical | Bleed | Size |
| Example | Ratio | (lb/T) | (g/m²) | Value | Value | (mm²) | Density | (mm²) | (micron) |
| 10 | ASA/amphoteric | 1.75 | 33.33 | 19.15 | 2.60 | 1.996 | 1.444 | 2.114 | 1.54 |
| | polymer 1/0.05 | | | | | | | | |
| 11 | ASA/amphoteric | 2.00 | 33.33 | 18.05 | 4.43 | 1.945 | 1.456 | 2.134 | |
| | polymer 1/0.05 | | | | | | | | |
| 12 | ASA/amphoteric | 1.75 | 33.00 | 17.95 | 3.43 | 1.978 | 1.440 | 2.142 | 1.27 |
| | polymer 1/0.1 | | | | | | | | |
| 13 | ASA/amphoteric | 2.00 | 34.33 | 18.65 | 2.86 | 1.974 | 1.448 | 2.107 | |
| | polymer 1/0.1 | | | | | | | | |
| 14 | ASA/amphoteric | 1.75 | 35.67 | 18.50 | 3.11 | 1.954 | 1.442 | 2.129 | 1.07 |
| | polymer 1/0.2 | | | | | | | | |
| 15 | ASA/amphoteric | 2.00 | 34.33 | 17.90 | 3.31 | 1.973 | 1.458 | 2.132 | |
| | polymer 1/0.2 | | | | | | | | |
| 16 | ASA/amphoteric | 1.75 | 35.33 | 18.95 | 2.46 | 1.990 | 1.436 | 2.159 | 0.89 |
| | polymer 1/0.5 | | | | | | | | |
| 17 | ASA/amphoteric | 2.00 | 35.33 | 18.80 | 2.77 | 1.980 | 1.440 | 2.132 | |
| | polymer 1/0.5 | | | | | | | | |
| 18 | ASA/amphoteric | 1.75 | 36.33 | 19.25 | 2.26 | 1.951 | 1.440 | 2.111 | 1.01 |
| | polymer 1/1 | | | | | | | | |
| 19 | ASA/amphoteric | 2.00 | 35.33 | 18.75 | 3.39 | 1.979 | 1.456 | 2.180 | |
| | polymer 1/1 | | | | | | | | |
| 20 | ASA/cationic | 1.75 | 35.67 | 18.55 | 2.92 | 1.993 | 1.462 | 2.128 | 1.01 |
| | polymer 1/0.05 | | | | | | | | |
| 21 | ASA/cationic | 2.00 | 35.00 | 17.85 | 3.60 | 1.967 | 1.454 | 2.116 | |
| | polymer 1/0.05 | | | | | | | | |
| 22 | ASA/cationic | 1.75 | 35.00 | 18.55 | 2.82 | 1.952 | 1.450 | 2.143 | 0.76 |
| | polymer 1/0.1 | | | | | | | | |
| 23 | ASA/cationic | 2.00 | 35.67 | 18.45 | 3.76 | 1.976 | 1.470 | 2.123 | |
| | polymer 1/0.1 | | | | | | | | |
| 24 | ASA/cationic | 1.75 | 35.33 | 19.10 | 3.09 | 1.947 | 1.450 | 2.141 | 0.71 |
| | polymer 1/0.2 | | | | | | | | |
| 25 | ASA/cationic | 2.00 | 34.67 | 18.45 | 3.40 | 1.966 | 1.464 | 2.113 | |
| | polymer 1/0.2 | | | | | | | | |
| 26 | ASA/cationic | 1.75 | 34.67 | 18.70 | 3.26 | 1.962 | 1.448 | 2.116 | 0.64 |
| | polymer 1/0.5 | | | | | | | | |
| 27 | ASA/cationic | 2.00 | 33.00 | 18.40 | 3.65 | 1.957 | 1.464 | 2.112 | |
| | polymer 1/0.5 | | | | | | | | |
| 28 | ASA/cationic | 1.75 | 33.67 | 16.95 | 4.58 | 1.952 | 1.464 | 2.093 | 0.60 |
| | polymer 1/1 | | | | | | | | |
| 29 | ASA/cationic | 2.00 | 28.00 | 16.80 | 4.77 | 1.934 | 1.474 | 2.064 | |
| | polymer 1/1 | | | | | | | | |
| 30 | ASA/starch 1/1 | 1.75 | 38.00 | 19.40 | 2.71 | 1.967 | 1.432 | 2.110 | 0.76 |
| Comparative | | | | | | | | | |
| 31 | ASA/starch 1/1 | 2.00 | 34.67 | 19.20 | 2.94 | 2.022 | 1.442 | 2.086 | |
| Comparative | | | | | | | | | |

All emulsions made with polymers were stable and had median particle size in the range of 0.60-1.54 microns. Sizing and print quality obtained with ASA/polymer emulsions were either better or equivalent to sizing and print quality obtained with the ASA/starch emulsion. There was no significant difference in performance between emulsions having different ASA to polymer ratios.

### Examples 32-45

Examples to illustrate emulsification of ASA with a copolymer of vinyl alcohol and vinylamine.

### Polymer H

A copolymer of vinyl alcohol and vinylamine containing 12 mole % of vinylamine and having molecular weight in the range from 80000 to 140000 daltons. The copolymer was a 10 weight percent solution in water and had pH equal to 4.0.

### Polymer K

A copolymer of vinyl alcohol and vinylamine containing 6 mole % of vinylamine and having molecular weight in the range from 80000 to 140000 daltons. The copolymer was a 10-weight percent solution in water and had pH equal to 4.0.

### Example 32

An ASA emulsion was prepared with Polymer H at an ASA/polymer solids ratio of 1/2, using Emulsification Procedure A. The emulsion was made by emulsification of 2.4 parts of Baysize S 180 size with 48.0 parts of Polymer H and 69.6 parts of deionized water adjusted to pH 4. This was Emulsion H1.

According to the Surface Application Procedure A, Paper A (70 g/m² sheets containing 14.9% calcium carbonate and internal size) was treated with a mixture of 3.77 parts of Emulsion H1 and 400 parts of Starch Solution A1 in such manner that 0.25 lb of ASA per ton of dry fiber was added.

### Example 33

The procedure of Example 32 was repeated, except that Paper A was treated with a mixture of 7.54 parts of Emulsion H1 and 400 parts of Starch Solution A1 in such manner that 0.5 lb of ASA per ton of dry fiber was added.

### Example 34

An ASA emulsion was prepared with Polymer H at an ASA/polymer solids ratio of 1/1, using Emulsification Procedure A. The emulsion was made by emulsification of 4.8 parts of Baysize S 180 size with 48.0 parts of Polymer H and 67.2 parts of deionized water adjusted to pH 4. This was Emulsion H2.

According to the Surface Application Procedure A, Paper A was treated with a mixture of 1.88 parts of Emulsion H2 and 400 parts of Starch Solution A1 in such manner that 0.25 lb of ASA per ton of dry fiber was added.

### Example 35

The procedure of Example 34 was repeated, except that Paper A was treated with a mixture of 3.77 parts of Emulsion H2 and 400 parts of Starch Solution A1 in such manner that 0.5 lb of ASA per ton of dry fiber was added.

### Example 36

An ASA emulsion was prepared with Polymer H at an ASA/polymer solids ratio of 1/0.5, using Emulsification Procedure A. The emulsion was made by emulsification of 4.8 parts of Baysize S 180 size with 24.0 parts of Polymer H and 91.2 parts of deionized water adjusted to pH 4. This was Emulsion H3.

According to the Surface Application Procedure A, Paper A was treated with a mixture of 1.88 parts of Emulsion H3 and 400 parts of Starch Solution A1 in such manner that 0.25 lb of ASA per ton of dry fiber was added.

### Example 37

The procedure of Example 36 was repeated, except that, Paper A was treated with a mixture of 3.77 parts of Emulsion H3 and 400 parts of Starch Solution A1 in such manner that 0.5 lb of ASA per ton of dry fiber was added.

### Example 38

An ASA emulsion was prepared with Polymer H at an ASA/polymer solids ratio of 1/0.2, using Emulsification Procedure A. The emulsion was made by emulsification of 4.8 parts of Baysize S 180 size with 9.6 parts of Polymer H and 105.6 parts of deionized water adjusted to pH 4. This was Emulsion H4.

According to the Surface Application Procedure A, Paper A was treated with a mixture of 1.88 parts of Emulsion H4 and 400 parts of Starch Solution A1 in such manner that 0.25 lb of ASA per ton of dry fiber was added.

### Example 39

The procedure of Example 38 was repeated, except that Paper A was treated with a mixture of 3.77 parts of Emulsion H4 and 400 parts of Starch Solution A1 in such manner that 0.5 lb of ASA per ton of dry fiber was added.

### Example 40

An ASA emulsion was prepared with Polymer K at an ASA/polymer solids ratio of 1/1, using Emulsification Procedure A. The emulsion was made by emulsification of 4.8 parts of Baysize S 180 size with 48.0 parts of Polymer K and 67.2 parts of deionized water adjusted to pH 4. This was Emulsion K1.

According to the Surface Application Procedure A, Paper A was treated with a mixture of 1.88 parts of Emulsion K1 and 400 parts of Starch Solution A1 in such manner that 0.25 lb of ASA per ton of dry fiber was added.

### Example 41

The procedure of Example 40 was repeated, except that Paper A was treated with a mixture of 3.77 parts of Emulsion K1 and 400 parts of Starch Solution A1 in such manner that 0.5 lb of ASA per ton of dry fiber was added.

### Example 42

### Comparative

An ASA emulsion was prepared with a Starch Solution A at an ASA/starch solids ratio of 1/1. The emulsion was made by emulsification of 13.08 parts of Baysize S 180 size with 86.89 parts Starch Solution A and 99.31 parts of deionized water, using a household blander on high speed for 90 sec. This was Emulsion L.

According to the Surface Application Procedure A, Paper A was treated with a mixture of 1.16 parts of Emulsion L and 400 parts of Starch Solution A1 in such manner that 0.25 lb of ASA per ton of dry fiber was added.

### Example 43

### Comparative

The procedure of Example 42 was repeated, except that Paper A was treated with a mixture of 2.32 parts of Emulsion L and 400 parts of Starch Solution A1 in such manner that 0.5 lb of ASA per ton of dry fiber was added.

### Example 44

### Comparative

According to the Surface Application Procedure A, Paper A was treated with a mixture of 3.37 parts of the 25.5-wt % surface size agent Baysize® S BMP polymer, a styrene-acrylate emulsion (Bayer Chemicals Corporation) and 400 parts of Starch Solution A1. In this manner, 2.0 lb of the active surface size agent per ton of dry fiber was added.

### Example 45

### Comparative

According to the Surface Application Procedure A, Paper A was treated with a mixture of 4.75 parts of the 25.5-wt % surface size agent Baysize® S BMP polymer, a styrene-acrylate emulsion (Bayer Chemicals Corporation) and 400 parts of Starch Solution A1. In this manner, 4.0 lb of the active surface size agent per ton of dry fiber was added.

### Summary of Examples 32-45

Ink penetration holdout (Test A), black image analysis (Test D), color bleed (Test E), and optical density (Test F) were measured on treated paper (Examples 32 through 45) and are presented in Table 4.

Median particle size of the emulsions was measured with Horiba LA 300 and was included in Table 4.

TABLE 4

| | | | | | | | | Emulsion |
|---|---|---|---|---|---|---|---|---|
| | | | | | Black | | | Median |
| | | ASA/ | ASA | Ink | Image | Black | Color | Particle |
| Example | Surface | Emulsifier | Dose | Penetration | Analysis | Optical | Bleed | Size |
| # | Size | Ratio | (lb/T) | (sec) | (mm²) | Density | (mm²) | (micron) |
| 32 | ASA/12 | 1/2 | 0.25 | 485.3 | 1.952 | 1.424 | 2.069 | 0.910 |
| | mole % | | | | | | | |
| | vinylamine | | | | | | | |
| 33 | ASA/12 | 1/2 | 0.50 | 629.8 | 1.939 | 1.450 | 2.034 | |
| | mole % | | | | | | | |
| | vinylamine | | | | | | | |
| 34 | ASA/12 | 1/1 | 0.25 | 449.9 | 1.956 | 1.440 | 2.068 | 0.740 |
| | mole % | | | | | | | |
| | vinylamine | | | | | | | |
| 35 | ASA/12 | 1/1 | 0.50 | 550.9 | 1.936 | 1.452 | 2.059 | |
| | mole % | | | | | | | |
| | vinylamine | | | | | | | |
| 36 | ASA/12 | 1/0.5 | 0.25 | 452.6 | 1.955 | 1.422 | 2.071 | 1.060 |
| | mole % | | | | | | | |
| | vinylamine | | | | | | | |
| 37 | ASA/12 | 1/0.5 | 0.50 | 542.1 | 1.929 | 1.442 | 2.058 | |
| | mole % | | | | | | | |
| | vinylamine | | | | | | | |
| 38 | ASA/12 | 1/0.2 | 0.25 | 367.9 | 1.957 | 1.420 | 2.082 | 1.220 |
| | mole % | | | | | | | |
| | vinylamine | | | | | | | |
| 39 | ASA/12 | 1/0.2 | 0.50 | 495.4 | 1.925 | 1.440 | 2.082 | |
| | mole % | | | | | | | |
| | vinylamine | | | | | | | |
| 40 | ASA/6 | 1/1 | 0.25 | 433.3 | 1.967 | 1.428 | 2.054 | 1.140 |
| | mole % | | | | | | | |
| | vinylamine | | | | | | | |
| 41 | ASA/6 | 1/1 | 0.50 | 534.7 | 1.952 | 1.428 | 2.047 | |
| | mole % | | | | | | | |
| | vinylamine | | | | | | | |
| 42 | ASA/starch | 1/1 | 0.25 | 408.1 | 1.994 | 1.420 | 2.079 | 0.690 |
| Comparative | | | | | | | | |
| 43 | ASA/starch | 1/1 | 0.50 | 580.8 | 1.963 | 1.438 | 2.070 | |
| Comparative | | | | | | | | |
| 44 | Surface | | 2.00 | 489.0 | 1.995 | 1.436 | 2.137 | |
| Comparative | size | | | | | | | |
| | agent | | | | | | | |
| 45 | Surface | | 4.00 | 718.9 | 1.959 | 1.446 | 2.144 | |
| Comparative | size | | | | | | | |
| | agent | | | | | | | |

ASA emulsions prepared with polymers containing vinylamine provided equivalent or better sizing than ASA emulsions prepared with starch. ASA emulsions prepared with polymers containing vinylamine provided better black image and color bleed than commercial surface size agent.

Overall, similar sizing and print quality performance were achieved with very small dose of ASA emulsion (0.25 lb/t ASA) than with 2 lb/T of the commercial surface sizing agent.

Although the present invention has been described in detail with reference to certain preferred versions thereof, other variations are possible. Therefore, the spirit and scope of the appended claims should not be limited to the description of the versions contained therein.

1-20. (canceled)

21. A process for making a sizing composition comprising the steps of:
(a) emulsifying an alkenylsuccinic anhydride component, optionally containing a surfactant, with an aqueous polymer solution, and thereby forming an emulsion, and
(b) combining the emulsion with a second component selected from the group consisting of cationic starches, non-ionic starches, anionic starches, water-soluble polymer, water and mixtures thereof, and thereby forming the sizing composition.

22. The process of claim 21, wherein the polymer is selected from the group consisting of vinyl addition polymers, condensation polymers, and combinations thereof.

23. The process of claim 21, wherein the surfactant component is present at a level ranging from about 0.1 weight % up to about 20 weight %, based on the alkenylsuccinic anhydride.

24. The process of claim 21, wherein the polymer component has a temperature ranging from about 4 C to about 66° C.

25. The process of claim 21, wherein the ASA component has a temperature ranging from about 4 C to about 66° C.

26. The process of claim 21, wherein the pressure at which the emulsion is made ranges from about 1 psig to about 150 psig.

27. The process of claim 21, wherein the temperature at which the emulsion is made ranges from about 40° F. to about 185° F.

28. The process of claim 21, wherein the emulsion is made with a shearing device having an inlet pressure that is at least about 1 psig.

29. The process of claim 21, wherein the emulsion is made with a shearing device having an inlet pressure ranging from about 1 psig to about 25 psig.

30. The process of claim 21, wherein the emulsion is made with a shearing device having an outlet pressure ranging from about 15 psig to about 160 psig.

31. The process of claim 21, wherein the emulsion is made under shear conditions created by a device selected from the group consisting of centrifugal pumps, static in-line mixers, peristaltic pumps, magnetic stirring bar in a beaker, overhead stirrer, and combinations thereof.

32-47. (canceled)
